(19) United States
(12) Patent Application Publication
(10) Pub. No.: US 2008/0032791 A1
(43) Pub. Date: Feb. 7, 2008

(54) Gaming machine

(75) Inventor: Norio Hosokawa, Tokyo (JP)

Correspondence Address: ARENT FOX LLP, 1050 CONNECTICUT AVENUE, N.W., SUITE 400, WASHINGTON, DC, 20036, US

(73) Assignee: ARUZE Corp.

(21) Appl. No.: 11/882,409

(22) Filed: Aug. 1, 2007

(30) Foreign Application Priority Data
Aug. 2, 2006 (JP) 2006-211134

(51) Int. Cl. A63F 13/02; A63F 13/00; A63F 9/24

(52) U.S. Cl. 463/31; 463/20; 463/43

(57) ABSTRACT

To provide a gaming machine which can increase an entertainment aspect by changing a disposition of a plurality of symbols and payout lines displayed on a display portion provided in the gaming machine, thus providing a visual change.

In a gaming machine, in which an execution of a game is possible by means of a game medium being inserted by a player, a disposition aspect 1(A), a disposition aspect 2(B) and a disposition aspect 3(C), as disposition aspects of a plurality of display areas which display symbols, and payout lines corresponding to the disposition aspects, are stored in a memory such as a memory. A processor selects one from among the plurality of disposition aspects stored in the memory, fixes a position of the display areas on a screen of a display, in accordance with the selected disposition aspect, and displays a symbol inside each display area. Then, the processor, in accordance with an instruction from the player, redisplays symbols to be displayed inside the disposed display areas.

### RELATED APPLICATION

This application claims the priority of Japanese Patent Application No. 2006-211134 filed on Aug. 2, 2006, which is incorporated herein by reference.

### BACKGROUND OF THE INVENTION

1. Technical Field

The present invention relates to a gaming machine which carries out a game using a game medium such as a coin or a bill.

2. Related Art

In a case of a heretofore known slot machine, as disclosed in U.S. Pat. No. 6,960,133 B1 or U.S. Pat. No. 6,012,983, when a player inserts a game medium such as a medal, or a coin or bill, into an insertion slot of the slot machine, and presses a spin button, the slot machine scrolls a plurality of symbols displayed on a display portion provided on a cabinet front. Also, the slot machine, when the player has pressed the spin button, predetermines kinds of symbol to be displayed on the display portion when the scrolling has been stopped. Then, the slot machine stops the scrolling in such a way that the determined symbols are displayed on the display portion, redisplaying the symbols. Subsequently, the slot machine pays out a dividend in accordance with a combination of the plurality of symbols redisplayed on the display portion when the scrolling of the symbols has stopped. Herein, whether or not the slot machine pays out the dividend is judged depending on combinations of symbols redisplayed along payout lines fixed in advance on the heretofore described display portion. That is, only in the event that, among the plurality of symbols displayed on the display portion when the scrolling of the symbols has stopped, a combination of symbols displayed along the heretofore described payout line matches one of a plurality of predetermined winning combinations, the slot machine pays out a dividend corresponding to the relevant matching winning combination.

A number of the symbols displayed on the display portion, and a number of the payout lines, differ depending on the slot machine. For example, the slot machine disclosed in U.S. Pat. No. 6,093,102 displays 15 symbols disposed in a three row by five column matrix formation. Also, this slot machine has all lines formed by passing through a display position of any one symbol, among three symbols displayed, in each column as the payout lines. That is, the number of the payout lines in the slot machine of U.S. Pat. No. 6,093,102 is 3×3×3×3×3=243. By this means, the slot machine, when redisplaying the symbols after scrolling the 15 symbols displayed on the display portion, in the event that a combination of 5 symbols displayed along any one payout line, among the 243 payout lines, matches a winning combination, pays out the dividend corresponding to the relevant matching winning combination.

However, in the heretofore known gaming machine, a display position of the symbols displayed on the display portion has been fixed. That is, in, for example, the slot machine of the heretofore described U.S. Pat. No. 6,093,102, the fifteen symbols are always displayed disposed in the three row by five column matrix formation, and this disposition never changes. For this reason, an advent is expected of a gaming machine, including a new entertainment aspect, which can cause the player greater enjoyment.

### SUMMARY OF THE INVENTION

The invention, therefore, has an object of providing a gaming machine which can increase an entertainment aspect by, as well as variously changing a disposition, that is, a display position, of a plurality of symbols displayed on a display portion provided in the gaming machine, changing payout lines in accordance with the change in the disposition of the symbols, thus providing a visual change.

A first aspect of the invention is a gaming machine including: a display; a memory which stores display positions of a plurality of symbols to be displayed on the display, and payout lines corresponding to the relevant display positions; and a processor which displays the plurality of symbols on the display based on the display positions stored in the memory, and controls a game based on the payout lines stored in the memory. The display has a plurality of display areas for displaying the symbols. The memory stores information relating to a position of each display area on a screen of the display in a plurality of ways. In other words, it stores a plurality of kinds of disposition aspect of the display areas. Also, the memory also stores payout lines corresponding to the stored plurality of kinds of disposition aspect of the display areas. The processor, when displaying the plurality of symbols on the display, fixes the position of each display area on the screen of the display in accordance with any one disposition aspect among the disposition aspects of the plurality of display areas stored in the memory. Then, the processor displays a symbol in each fixed display area position. Also, the processor carries out a redisplay of the symbols displayed, in accordance with an instruction from the player, as a result of which, in the event that a combination of symbols which matches a winning combination has been displayed, it pays out a dividend to the player corresponding to the relevant winning combination. At this time, the combinations of symbols compared with the winning combination are the combinations of symbols redisplayed in positions through which pass the payout lines corresponding to the disposition aspect of each display area referred to when displaying the plurality of symbols on the display.

According to the gaming machine of the invention, as it is possible to appropriately select the disposition aspect of each display area stored in the memory, and display the plurality of symbols in accordance with the selected disposition aspect, it being possible to avoid the display position of the plurality of symbols on the screen of the display becoming standardized, a display of the symbols rich in visual variety is possible.

Also, the invention can employ a variety of methods of selecting the disposition aspect of each display area, and the payout lines corresponding to the relevant disposition aspect, stored in the memory.

As one of those, in a second aspect of the invention, when a game start operation has been carried out by the player, the processor selects any one among the disposition aspects of the display areas stored in the memory. Then, the processor fixes the position of each display area on the screen of the display in accordance with the selected disposition aspect, and displays a symbol in each fixed display area. Also, the processor carries out the redisplay of the symbols displayed, in accordance with the instruction from the player, as a result of which, in the event that the combination of symbols which matches the winning combination has been displayed, it pays out the dividend to the player corresponding to the relevant winning combination. At this time, the combinations of symbols compared with the winning combination are the combinations of symbols redisplayed in positions through which pass the payout lines corresponding to the disposition aspect of each display area referred to when displaying the plurality of symbols on the display.

According to the heretofore described gaming machine in order to start the game, when the player inserts the game medium into the gaming machine, the disposition of the plurality of symbols displayed on the display changes at random. For this reason, being rich in visual variety, it is possible to prevent the player from becoming easily bored.

Also, a third aspect of the invention, providing the gaming machine with a selection switch, enables a selection of any one of the plurality of disposition aspects stored in the memory, via the selection switch. In this case, the processor fixes the position of each display area on the screen of the display in accordance with the disposition aspect, among the disposition aspects of the display areas stored in the memory, which the player has selected via the selection switch, and displays a symbol in each relevant display area. Also, the processor carries out the redisplay of the symbols displayed, in accordance with the instruction from the player, as a result of which, in the event that the combination of symbols which matches the winning combination has been displayed, it pays out the dividend to the player corresponding to the relevant winning combination. At this time, the combinations of symbols compared with the winning combination are the combinations of symbols redisplayed in positions through which pass the payout lines corresponding to the disposition aspect of each display area referred to when displaying the plurality of symbols on the display.

According to the heretofore described gaming machine, the player can select a disposition aspect of the symbols, from among the plurality of disposition aspects relating to the symbols stored in the memory, which is to his or her liking. That is, it is possible to provide the disposition aspect of the symbols which is to the player's liking.

Also, in a fourth aspect of the invention, the processor, when carrying out the redisplay of the displayed symbols in accordance with the instruction from the player, in the event that a predetermined combination of symbols, among the redisplayed symbols, is displayed along the payout lines, selects any one among the disposition aspects of the display areas stored in the memory. By this means, the processor fixes the position of each display area on the screen of the display in accordance with the selected disposition aspect, and displays a symbol in each relevant display area. Thereafter, the processor carries out the redisplay of the symbols displayed on the display, in accordance with the instruction from the player, and carries out a control relating to the game.

According to the heretofore described gaming machine, in the event that a combination of symbols, among the plurality of redisplayed symbols, displayed along the payout line, is the predetermined combination of symbols, the disposition aspect of the symbols changes. For this reason, the combinations of symbols along the payout lines not only have a role of deciding whether or not the dividend is paid out, but also have a new role of determining whether or not the disposition aspect of the plurality of symbols changes. By this means, in comparison with heretofore known gaming machines, there being a possibility of being able to cause the player to have a greater interest in the combinations of symbols along the payout lines, it is possible to make it unlikely for the player to become bored.

Also, a fifth aspect of the invention providing the game machine with a timer, every time the timer measures a predetermined time, the processor selects any one among the disposition aspects of the display areas stored in the memory. Then, the processor fixes the position of each display area on the screen of the display in accordance with the selected disposition aspect, and displays a symbol in each relevant display area. Thereafter, the processor carries out the redisplay of the symbols displayed on the display, in accordance with the instruction from the player, and carries out the control relating to the game.

According to the heretofore described gaming machine, when carrying out the game, the disposition aspect of the symbols changes every time a predetermined time elapses. For this reason, even when a paying out of a high dividend in the gaming machine does not occur for a long time, and the player is playing the game aimlessly, by adding to the game an extra feature of changing the disposition aspect of the symbols, it is possible to prevent the player from becoming easily bored.

According to the invention, it is possible to increase an entertainment aspect by, as well as variously changing the disposition, that is, the display position, of the plurality of symbols displayed on the display portion provided in the gaming machine, changing the payout lines in accordance with the change in the disposition of the symbols, thus providing a visual change.

Additional objects and advantage of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE INVENTION OF THE DRAWINGS

The accompanying drawings, which are incorporated in and constitute apart of the specification, illustrate embodiments of the invention, and together with the general description given above and the detailed description of the embodiments given below, serve to explain the principals of the invention.

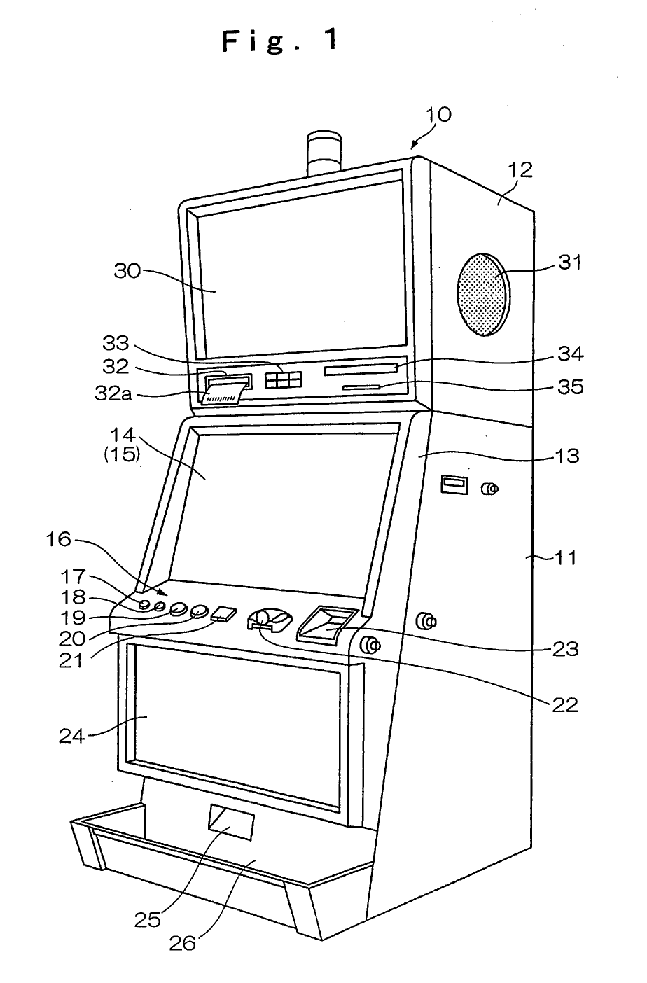

FIG. 1 is a perspective view showing an external appearance of a slot machine as one example of a gaming machine in a first embodiment of the invention;

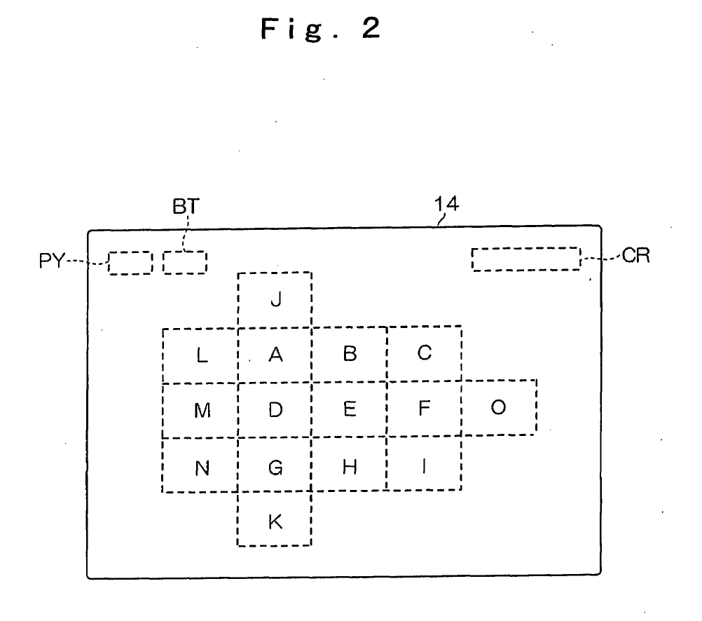

FIG. 2 is an explanatory diagram for describing display details of an image display device included in the gaming machine in the first embodiment of the invention;

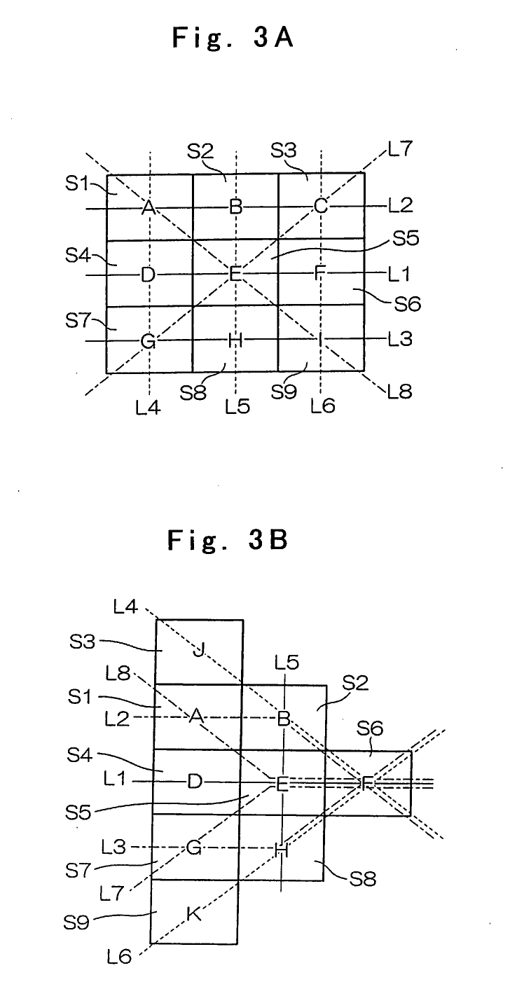

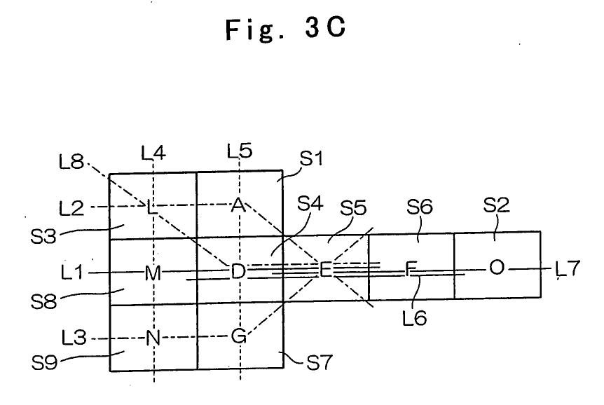

FIGS. 3A, 3B and 3C are explanatory diagrams for describing disposition aspects of display areas disposed on a screen of the image display device included in the gaming machine in the first embodiment of the invention;

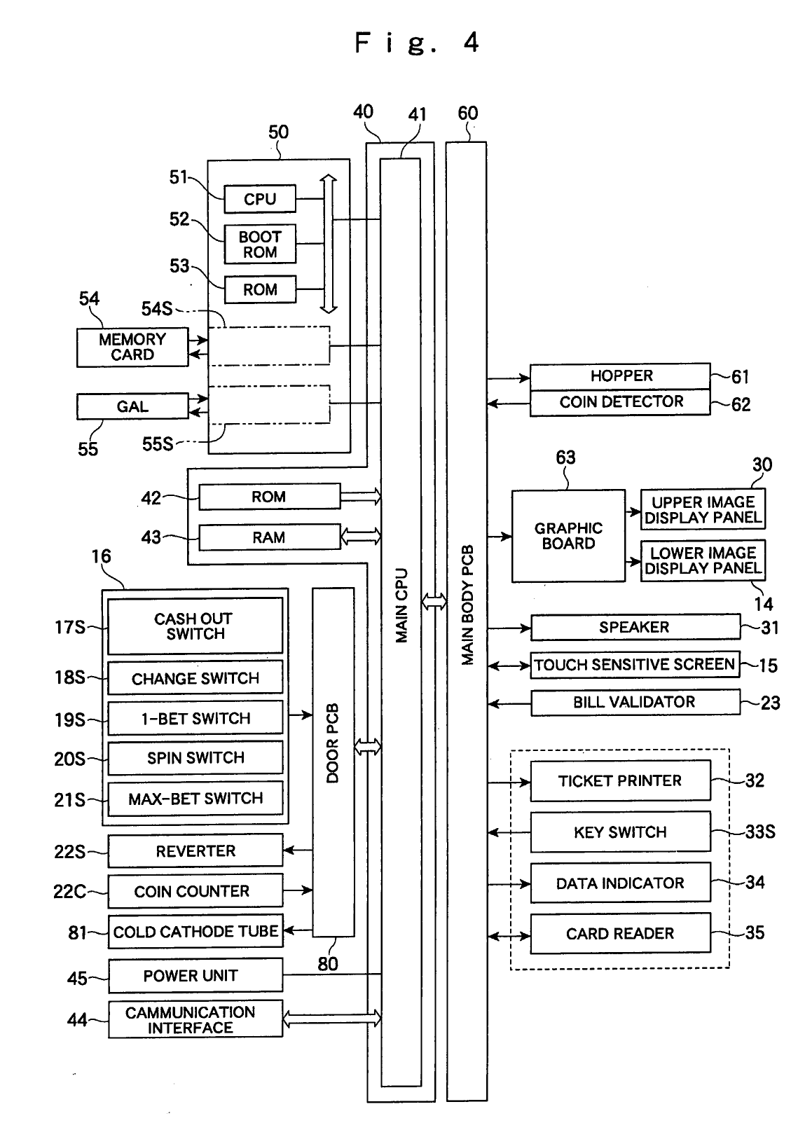

FIG. 4 is a block diagram showing a configuration of a control device included in the gaming machine in the first embodiment of the invention;

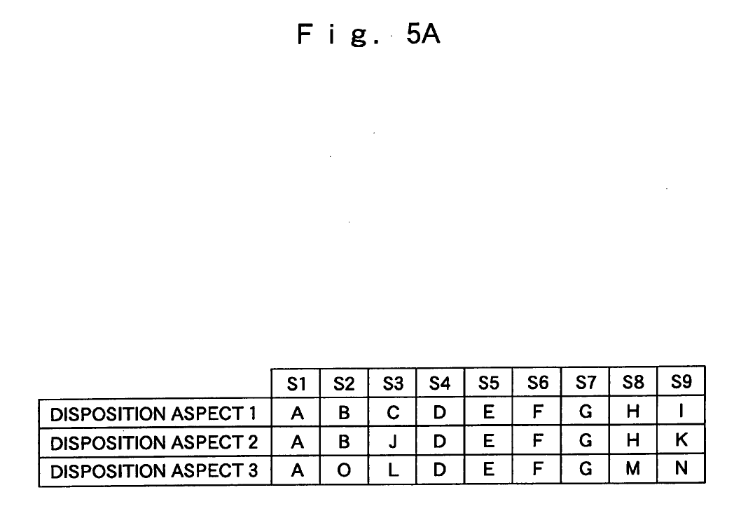

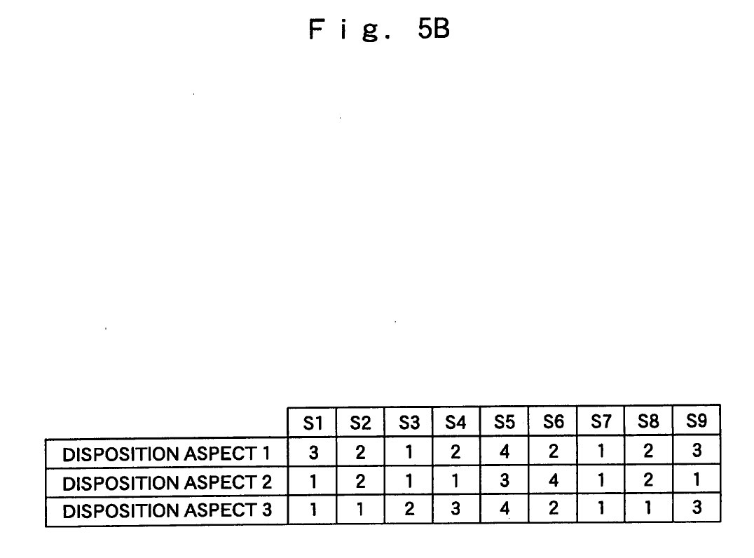

FIGS. 5A and 5B are explanatory diagrams for describing details of data referred to when processing a game program executed by the gaming machine in the first embodiment of the invention;

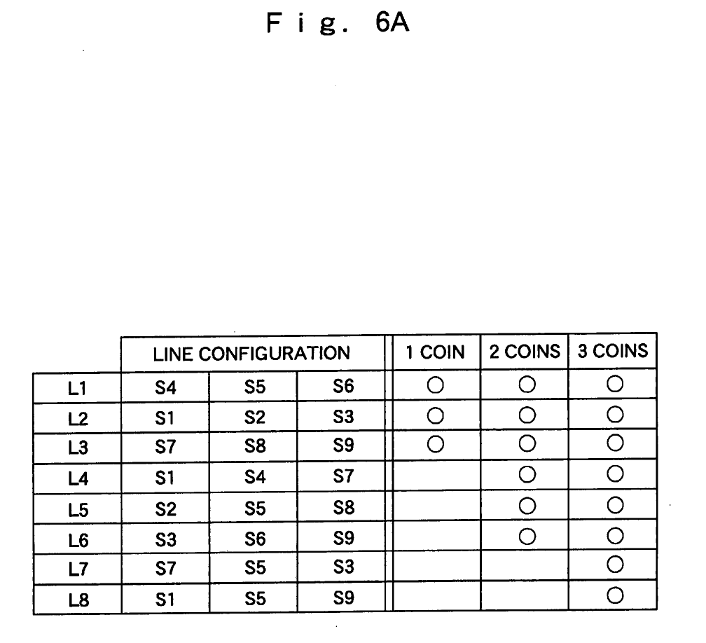

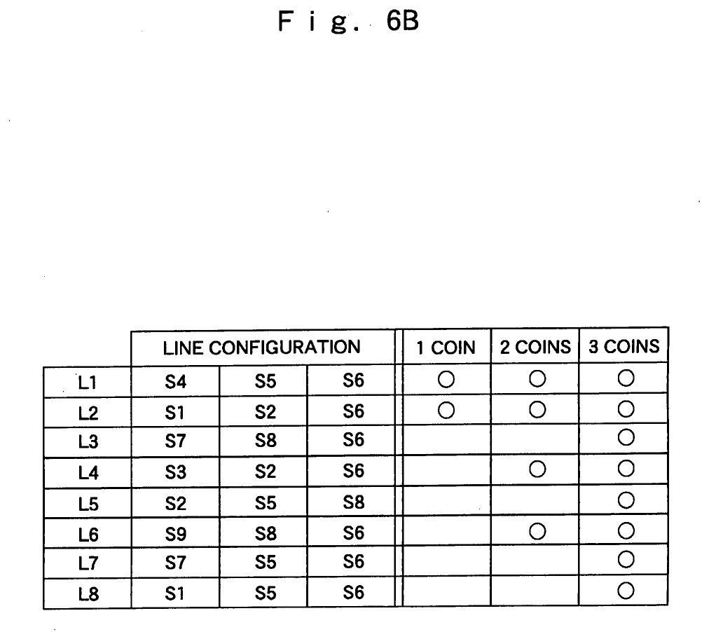

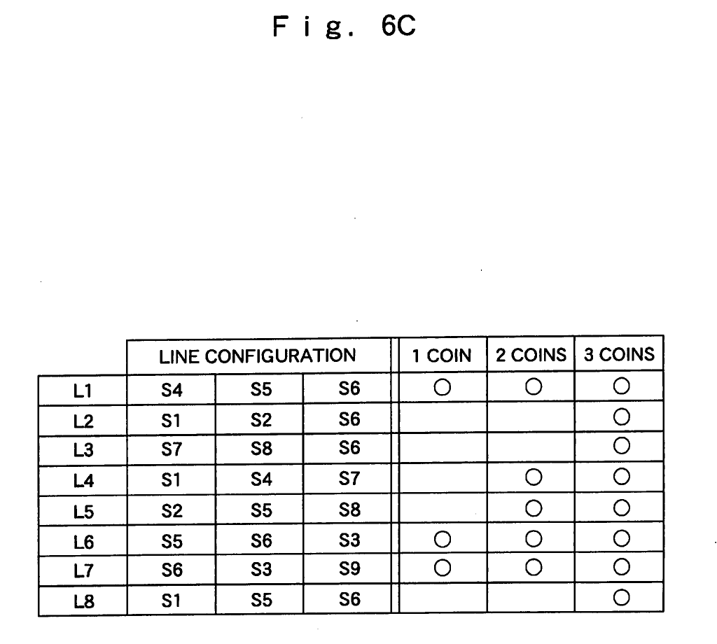

FIGS. 6A to 6C are explanatory diagrams for describing details of data referred to when processing the game program executed by the gaming machine in the first embodiment of the invention;

FIG. 7 is a flowchart showing processing details of a basic game program executed by the gaming machine in the first embodiment of the invention;

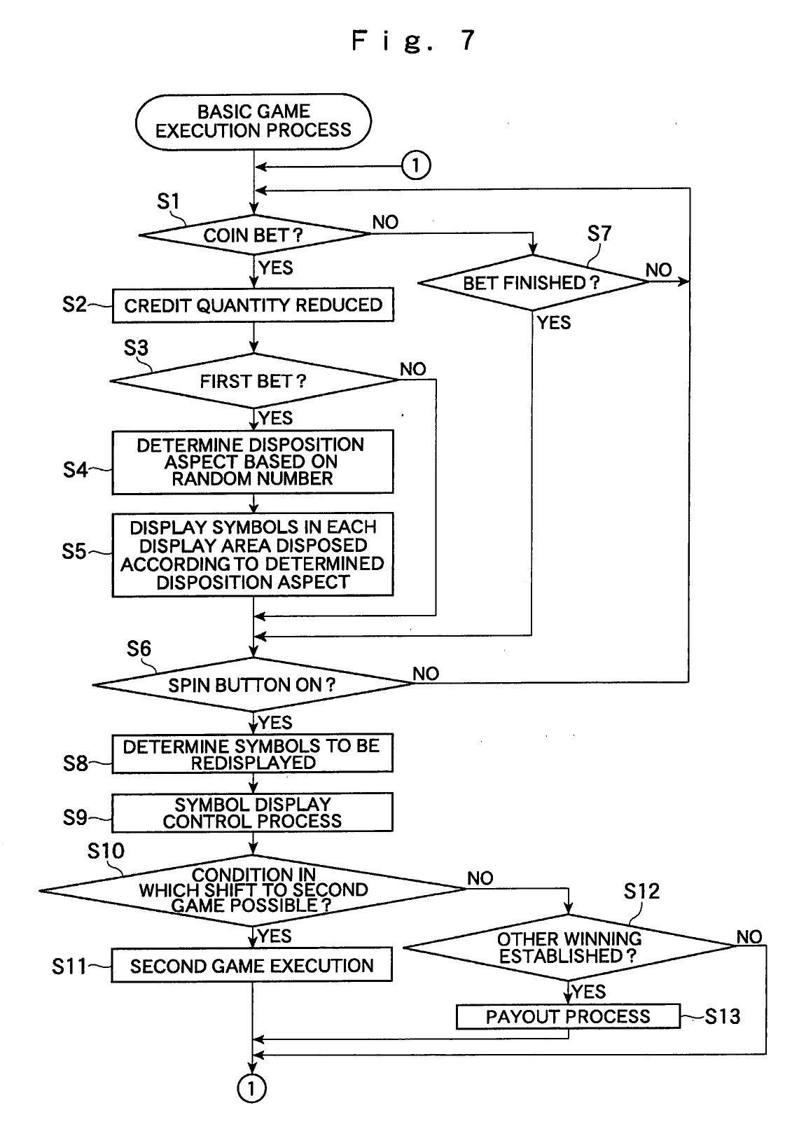

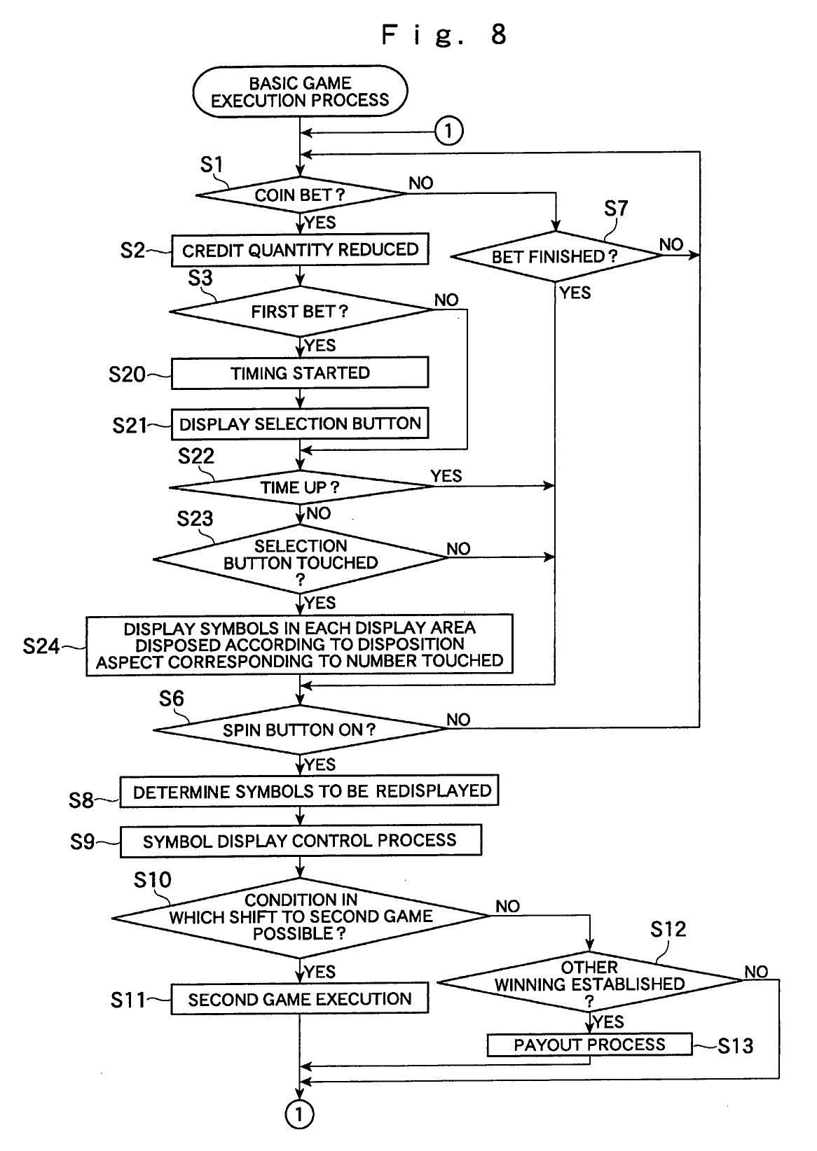

FIG. 8 is a flowchart showing processing details of a basic game program executed by a gaming machine in a second embodiment of the invention;

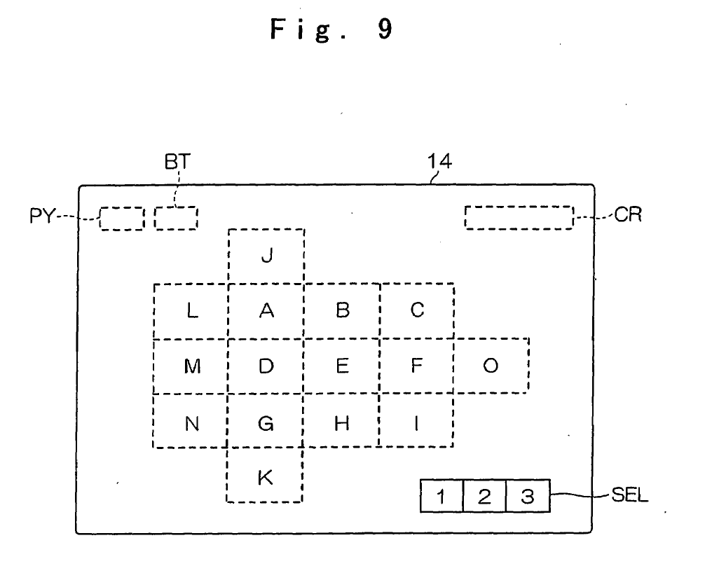

FIG. 9 is an explanatory diagram for describing display details of an image display device included in the gaming machine in the second embodiment of the invention;

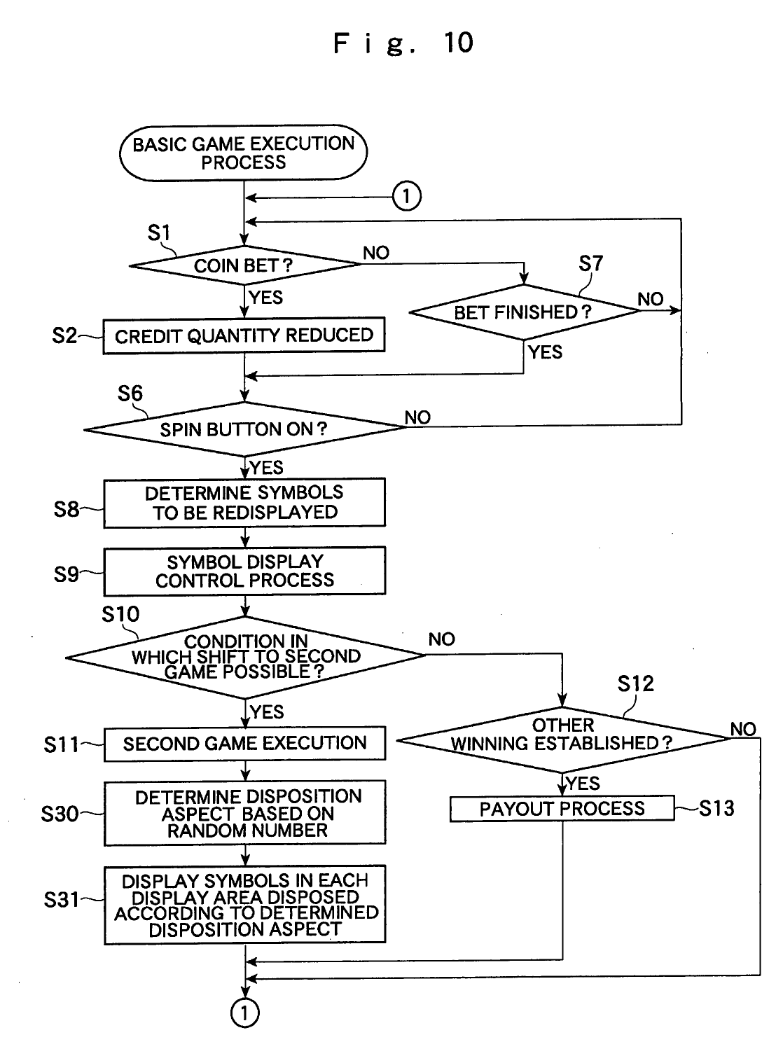

FIG. 10 is a flowchart showing processing details of a basic game program executed by a gaming machine in a third embodiment of the invention; and

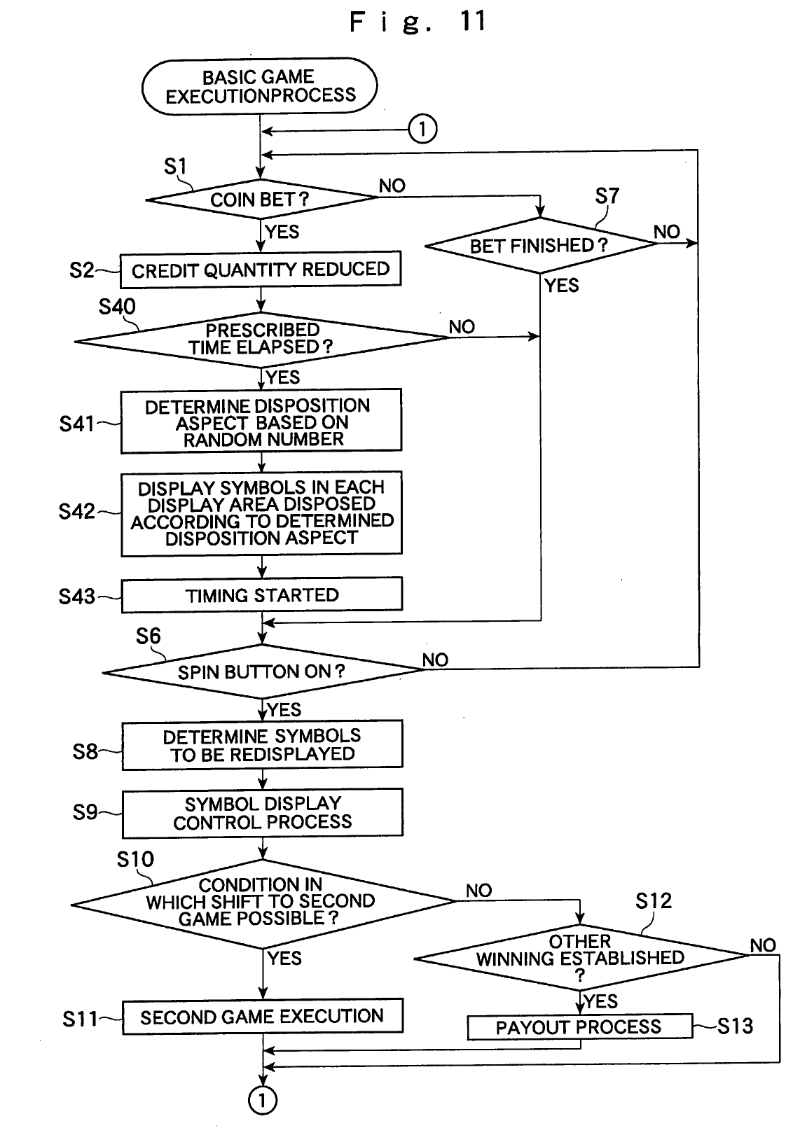

FIG. 11 is a flowchart showing processing details of a basic game program executed by a gaming machine in a fourth embodiment of the invention.

### DESCRIPTION OF THE PREFERRED EMBODIMENTS

Hereafter, a description will be given of a gaming machine of the invention, referring to the drawings. In the following description, a slot machine is given as an example of the gaming machine.

### First Embodiment

A description will be given of a configuration of a slot machine according to a first embodiment of the invention, referring to FIG. 1. FIG. 1 is a perspective view showing an external view of a slot machine 10 according to the first embodiment. In the slot machine 10, a unit game is executed by a game start operation being carried out by a player, for example, by a game medium being inserted by the player. A coin, a bill, or electronic valuable information equivalent to them, is used as the game medium for executing the unit game. However, the game medium not being limited to the above, it is also acceptable to use, for example, a medal, a token, electronic money or a ticket. Herein, as the ticket, there is, for example, a bar-coded ticket, such as to be described hereafter, and the like.

As shown in FIG. 1, the slot machine 10 includes a cabinet 11, a top box 12 disposed on top of the cabinet 11, and a main door 13 provided on a front of the cabinet 11. A lower image display panel 14, which is a liquid crystal image display device, is provided as a display in a front of the main door 13. Although a description will be given hereafter of detailed display details of the lower image display panel 14, nine symbols being displayed on the lower image display panel 14, in the event that the player carries out an instruction for a redisplay, each of the nine symbols scroll displays a plurality of kinds of symbol, exactly as though a reel on which a plurality of kinds of symbol are depicted were rotating. Then, the scrolling stops when a predetermined time elapses, and a kind of symbol differing from that before the scrolling or, in a certain case, the same kind of symbol as that before the scrolling, is newly displayed. Hereafter, the scrolling of the symbol displayed on the lower image display panel 14, and the symbol subsequently being newly displayed, will be referred as the redisplay. When the redisplay is carried out, in the event that a combination of symbols displayed along a predetermined payout line matches a winning combination, the slot machine 10 pays the player a number of coins corresponding to a dividend of the winning combination. A touch sensitive screen 15 being provided on a screen surface of the lower image display panel 14, the player can input various kinds of instruction into the slot machine 10 by touching the touch sensitive screen 15.

A control panel 16 is provided below the lower image display panel 14. A CASH OUT button 17, a CHANGE button 18, a 1-BET button 19, a SPIN button 20 and a MAX-BET button 21 are provided on the control panel 16. The CASH OUT button 17 is a button for inputting an instruction to pay credited coins back to the player. The CHANGE button 18 is a button used when requesting a changing of money from an attendant of a game establishment in which the slot machine 10 is installed. The 1-BET button 19 is a button for inputting an instruction to bet one coin, from among the credited coins, on the game. The SPIN button 20 is a button for inputting an instruction to cause the redisplay of the symbol. The MAX-BET button 21 is a button for inputting an instruction to bet a maximum number (for example, three) of coins, from among the credited coins, which can be bet on one game.

A coin acceptor 22 is provided to the right of the heretofore described various buttons. By this means, in the slot machine 10, as a method of betting the coin, as well as pressing the heretofore described 1-BET button 19 or MAX-BET button 21, there is a method which involves inserting the coin via the coin acceptor 22. A bill validator 23, as well as distinguishing whether or not a bill is legitimate, accepts a legitimate bill into the cabinet 11. It is also acceptable that the bill validator 23 is configured in such a way as to be able to read a bar-coded ticket 32a, to be described hereafter. A belly glass 24, on which is depicted a character or the like of the slot machine 10, is provided below the control panel 16. A coin payout opening 25 for paying the coins to the player is provided below the belly glass 24. Also, the coins paid out from the coin payout opening 25 are collected in a coin tray 26 provided in a lowermost front of the main door 13.

An upper image display panel 30 is provided on a front of the top box 12 provided on top of the cabinet 11. The upper image display panel 30 includes a liquid crystal panel on which is displayed, for example, an effect image, or an image representing an introduction of game details or an explanation of game rules. Also, a speaker 31 for emitting a sound is provided on the top box 12. A ticket printer 32, a keypad 33, a data indicator 34 and a card reader 35 are provided below the upper image display panel 30. The ticket printer 32 prints a bar code, into which are encoded data such as a credit quantity, a date and time, and an identification number of the slot machine 10, onto a ticket, and outputs the ticket as the bar-coded ticket 32a. The player can also play on another slot machine using the bar-coded ticket 32a. Also, it is also possible to change the bar-coded ticket 32a for a bill or the like with a cashier etc. at the game establishment. The keypad 33 is for inputting instructions or data relating to an issuing or the like of the heretofore described bar-coded ticket 32a. The data indicator 34, being configured of a fluorescent display or the like, displays, for example, data input by the player via the keypad 33, or data read by the card reader 35. The card reader 35 reads data from a memory embedded in a smart card, and writes the data onto the relevant memory. The smart card is a card which the player possesses, on which are stored, for example, data for identifying the player and data relating to a history of a game which the player has played.

Next, a description will be given of the previously mentioned display details of the lower image display panel 14, referring to FIG. 2. FIG. 2 shows a screen of the lower image display panel 14. As shown in the figure, a payout quantity display area PY and a BET quantity display area BT are positioned in a top left of the screen of the lower image display panel 14. A number of coins to be paid to the player is displayed in the payout quantity display area PY when one game has finished. A number of coins which the player has bet on one game is displayed in the BET quantity display area BT. A credit quantity display area CR is positioned in a top right of the screen of the lower image display panel 14. A number of credited coins is displayed in the credit quantity display area CR. 15 sections A to O, in which display areas for displaying symbols can be disposed, are positioned in an approximate center of the screen of the lower image display panel 14. The slot machine 10 disposes the display areas for displaying the symbols in nine sections, from among the 15 sections A to O. Then, it carries out the display of a symbol in each of the nine disposed display areas.

Next, a description will be given of a disposition aspect, with respect to the sections A to O, of the nine display areas S1 to S9, referring to FIGS. 3A to 3C. Herein, the disposition aspect refers to an aspect which the nine disposed display areas S1 to S9 take on with respect to the 15 sections A to O. The slot machine 10 is equipped with three kinds of disposition aspect of the nine display areas S1 to S9. Of the three kinds of disposition aspect, one is as shown in FIG. 3A. In this disposition aspect (hereafter referred to as a disposition aspect 1), the display area S1 is disposed in the section A, the display area S2 in the section B, the display area S3 in the section C, the display area S4 in the section D, the display area S5 in the section E, the display area S6 in the section F, the display area S7 in the section G, the display area S8 in the section H, and the display area S9 in the section I. By this means, in the disposition aspect 1, the display areas S1 to S9 are disposed in a three row by three column matrix formation. Of the three kinds of disposition aspect, a second is as shown in FIG. 3B. In this disposition aspect (hereafter referred to as a disposition aspect 2), the display area S3, from the disposition aspect shown in FIG. 3A, is disposed in the section J, and the display area S9 is disposed in the section K. Of the three kinds of disposition aspect, a third is as shown in FIG. 3C. In this disposition aspect (hereafter referred to as a disposition aspect 3), the display area S2, from the disposition aspect shown in FIG. 3A, is disposed in the section O, the display area S3 is disposed in the section L, the display area S8 is disposed in the section M, and the display area S9 is disposed in the section N.

In the three kinds of disposition aspect shown in FIGS. 3A to 3C, eight payout lines L1 to L8 are fixed for each disposition aspect. In the disposition aspect 1 shown in FIG. 3A, the payout line L1 is a line which passes through the display areas S4, S5 and S6 (sections D, E and F). The payout line L2 is a line which passes through the display areas S1, S2 and S3 (sections A, B and C). The payout line L3 is a line which passes through the display areas S7, S8 and S9 (sections G, H and I). The payout line L4 is a line which passes through the display areas S1, S4 and S7 (sections A, D and G). The payout line L5 is a line which passes through the display areas S2, S5 and S8 (sections B, E and H). The payout line L6 is a line which passes through the display areas S3, S6 and S9 (sections C, F and I). The payout line L7 is a line which passes through the display areas S3, S6 and S9 (sections C, F and I). The payout line L8 is a line which passes through the display areas S3, S6 and S9 (sections C, F and I).

In the disposition aspect 2 shown in FIG. 3B, the payout line L1 is a line which passes through the display areas S4, S5 and S6 (sections D, E and F). The payout line L2 is a line which passes through the display areas S1, S2 and S6 (sections A, B and F). The payout line L3 is a line which passes through the display areas S7, S8 and S6 (sections G, H and F). The payout line L4 is a line which passes through the display areas S3, S2 and S6 (sections J, B and F). The payout line L5 is a line which passes through the display areas S2, S5 and S8 (sections B, E and H). The payout line L6 is a line which passes through the display areas S9, S8 and S6 (sections K, H and F). The payout line L7 is a line which passes through the display areas S7, S5 and S6 (sections G, E and F). The payout line L8 is a line which passes through the display areas S1, S5 and S6 (sections A, E and F).

In the disposition aspect 3 shown in FIG. 3C, the payout line L1 is a line which passes through the display areas S8, S4 and S5 (sections M, D and E). The payout line L2 is a line which passes through the display areas S3, S1 and S5 (sections L, A and E). The payout line L3 is a line which passes through the display areas S9, S7 and S5 (sections N, G and E). The payout line L4 is a line which passes through the display areas S3, S8 and S9 (sections L, M and N). The payout line L5 is a line which passes through the display areas S1, S4 and S7 (sections A, D and G). The payout line L6 is a line which passes through the display areas S4, S5 and S6 (sections D, E and F). The payout line L7 is a line which passes through the display areas S5, S6 and S2 (sections E, F and O). The payout line L8 is a line which passes through the display areas S3, S4 and S5 (sections L, A and E).

Also, payout lines, among the eight payout lines in each of the heretofore described disposition aspects, seen to be activated in response to the number of coins bet on one game differ for each disposition aspect. That is, in the disposition aspect 1 shown in FIG. 3A, in the event that the number of coins bet on one game is one, only the payout lines L1, L2 and L3 are considered to be activated. That is, in the event that the number of coins bet on one game is one, even in the event that, among the symbols redisplayed in each display area, a combination of symbols which matches a winning combination is displayed along one of the payout lines L4 to L8, no coins are paid to the player. Also, in the event that the number of coins bet on one game is two, the payout lines L1 to L6 are considered to be activated, while in the event that the number of coins bet on one game is three, all the payout lines L1 to L8 are considered to be activated.

In the disposition aspect 2 shown in FIG. 3B, in the event that the number of coins bet on one game is one, only the payout lines L1 and L2 are considered to be activated. Also, in the event that the number of coins bet on one game is two, the payout lines L1, L2, L4 and L6 are considered to be activated. Furthermore, in the event that the number of coins bet on one game is three, all the payout lines L1 to L8 are considered to be activated. In the disposition aspect 3 shown in FIG. 3C, in the event that the number of coins bet on one game is one, only the payout lines L1, L6 and L7 are considered to be activated. Also, in the event that the number of coins bet on one game is two, the payout lines L1, L6, L7, L4 and L5 are considered to be activated. Furthermore, in the event that the number of coins bet on one game is three, all the payout lines L1 to L8 are considered to be activated.

In this way, in the slot machine 10, the 15 sections A to O being fixed inside the screen of the lower image display panel 14, the three kinds of disposition aspect for disposing the nine display areas with respect to these sections are fixed. Also, unique payout lines are fixed for each distribution aspect.

Next, a description will be given of a configuration of a control circuit of the slot machine 10, referring to FIG. 4. FIG. 4 is a block diagram showing the configuration of the control circuit of the slot machine 10. As shown in the figure, the control circuit is configured of components such as a mother board 40, a gaming board 50, a main body PCB (Printed Circuit Board) 60, a door PCB 80, and various switches and sensors. The gaming board 50 includes a CPU 51, a boot ROM 52 and an ROM 53, which are mutually connected via an internal bus, a card slot 54S compatible with a memory card 54, and an IC socket 55S compatible with a GAL (Generic Array Logic) 55.

The CPU 51, boot ROM 52 and ROM 53, which are mutually connected via the internal bus, are connected to the mother board 40 via a PCI (Peripheral Components Interconnect) bus. The PCI bus, as well as carrying out a signal transmission between the mother board 40 and the gaming board 50, carries out a supply of power from the mother board 40 to the gaming board 50. A preliminary authentication program, and a program (a boot code) and the like for the CPU 51 to boot up the preliminary authentication program, are stored in the boot ROM 52. Country identification information and an authentication program are stored in the ROM 53. The authentication program is a program (an alteration checking program) for authenticating a game program and a game system program. The authentication program is a program for carrying out a confirmation and certification that the game program and game system program have not been altered. That is, the authentication program is described in accordance with a procedure which carries out the authentication of the game program and game system program. The preliminary authentication program is a program for authenticating the heretofore described authentication program. The preliminary authentication program is described in accordance with a procedure which carries out a certification that the authentication program which is a subject of an authentication process has not been altered, that is, the authentication of the authentication program.

The memory card 54 stores the game program, the game system program, and various kinds of data for carrying out a process relating to the game. A first program for executing a basic game, a second program for executing a second game, and the like are included in the game program written onto the memory card 54 as programs related to an implementation of the game. The second game is a game, among a prescribed number of games, in which, compared to the basic game, a high dividend is granted to the player. Also, a redisplayed symbol determination process program is included in the game program. The redisplayed symbol determination process program is a program for determining the redisplayed symbols. Symbol weighing data corresponding to a plurality of kinds of payout ratio (for example, 80%, 84% and 88%) are included in the redisplayed symbol determination process program. The symbol weighing data are data which indicate a correlation between a unique code number appended to each of the plurality of symbols which may be displayed in each of the display areas S1 to S9, and one or a plurality of random numbers belonging to a prescribed range of numbers (0 to 256). The payout ratio being fixed based on payout ratio setting data transmitted from the GAL 55, the redisplayed symbol determination process is carried out based on symbol weighing data corresponding to this payout ratio. Also, in addition to image data and sound data transmitted during the game, data fixing a plurality of versions of winning combination, and a dividend corresponding to each winning combination, are included in the game program. A winning combination which results in the heretofore described second game being started is included among the winning combinations.

Furthermore, as shown in FIGS. 5A, 5B and 6A to 6C, the following kind of data, referred to when carrying out a display control of the symbols, are also included in the game program. FIG. 5A represents a correlation between the display areas S1 to S9, and the sections A to O, in each kind of disposition aspect of the display areas described referring to FIGS. 3A to 3C. Also, FIG. 5B is data which, in each kind of disposition aspect of the display areas, after the symbol displayed in each of the display areas S1 to S9 is caused to scroll, fixes an order for stopping the scrolling. That is, the data shown in FIG. 5B indicates that, in the disposition aspect 1, after starting the scrolling of the symbols displayed in the display areas S1 to S9, firstly, the scrolling in the display areas S3 and S7 is stopped, then the scrolling in the display areas S2, S4, S6 and S8 is stopped, furthermore, the scrolling in the display areas S1 and S9 is stopped, and finally, the scrolling in the display area S5 is stopped. Also, in the disposition aspect 2, firstly, the scrolling in the display areas S1, S3, S4, S7 and S9 is stopped, then the scrolling in the display areas S2 and S8 is stopped, furthermore, the scrolling in the display area S5 is stopped, and finally, the scrolling in the display area S6 is stopped. Also, in the disposition aspect 3, firstly, the scrolling in the display areas S1, S2, S7 and S8 is stopped, then the scrolling in the display areas S3 and S6 is stopped, furthermore, the scrolling in the display areas S4 and S9 is stopped, and finally, the scrolling in the display area S5 is stopped.

Also, FIGS. 6A to 6C show data relating to the payout lines in each disposition aspect of the display areas. FIG. 6A is data relating to the payout lines in the disposition aspect 1, FIG. 6B is data relating to the payout lines in the disposition aspect 2, and FIG. 6C is data relating to the payout lines in the disposition aspect 3. In FIGS. 6A to 6C, a “line configuration” column shows, as already described referring to FIGS. 3A to 3C, which display areas the payout lines L1 to L8 in each disposition aspect pass through. Also, columns “one coin”, “two coins” and “three coins” showing payout lines considered to be activated in accordance with the number of coins which the player has bet on one game, they show that, in each column, payout lines marked with a “ [symbol] ” are considered to be activated payout lines. As the relationship between the number of coins bet on one game, and the payout lines considered to be activated, has already been described referring to FIGS. 3A to 3C, a detailed description will be omitted here.

The card slot 54S, being configured in such a way that the memory card 54 can be inserted into and removed from it, is connected to the mother board 40 via an IDE (Integrated Device Electronics) bus. Consequently, by removing the memory card 54 from the card slot 54S, writing another game program and game system program onto the memory card 54, and inserting the memory card 54 into the card slot 54S, it is possible to change a type and details of the game carried out on the slot machine 10. The GAL 55 including a plurality of input ports and output ports, when data are input into the input ports, data corresponding to the data are output from the output ports. The data output from the output ports are the heretofore described payout ratio setting data. Also, the IC socket 55S, being configured in such a way that the GAL 55 can be attached to and removed from it, is connected to the mother board 40 via the PCI bus. Consequently, by removing the GAL 55 from the IC socket 55S, rewriting the program stored in the GAL 55, and attaching the GAL to the IC socket 55S, it is possible to change the payout ratio setting data transmitted from the GAL 55.

The mother board 40 includes a main CPU 41 (a processor), an ROM 42, an RAM 43 and a communication interface 44. The main CPU 41 includes a function as a controller which controls a whole of the slot machine 10. In particular, the main CPU 41 carries out a control causing the nine symbols displayed on the lower image display panel 14 to scroll inside the display areas, when the player has bet a credit and pressed the SPIN button 20, a control determining, before stopping the scrolling, symbols to be redisplayed, and a control stopping the scrolling in such a way as to actually stop the determined symbols in the display areas of the lower image display panel 14. Also, the main CPU 41, in the event that a combination of symbols redisplayed along a payout line is a specific combination, shifts to a process for executing the previously described second game. Furthermore, the main CPU 41, having a built-in timer, can time a given time, as necessary, using the timer.

A program such as a BIOS (Basic Input/Output System) executed by the main CPU 41 being stored in the ROM 42, permanently used data are also stored. Also, when the BIOS stored in the ROM 42 is executed by the main CPU 41, as well as a process of initializing each peripheral device being carried out, a process of reading the game program, the game system program and the various data stored in the memory card 54 via the gaming board 50 is started, and they are moved to the RAM 43 or the like. The various data and programs used when the main CPU 41 carries out the processes are stored in the RAM 43. That is, the RAM 43 corresponds to a memory which stores the data relating to the disposition aspects of the display areas shown in FIG. 5A, and the data relating to the payout lines shown in FIGS. 6A to 6C. Also, the RAM 43 includes an area which stores the number of coins bet by the player, the number of credited coins, and the like. The communication interface 44 is for carrying out a communication with a host computer or the like provided in the game establishment, via a communication line.

Also, a main body PCB 60 and a door PCB 80 are each connected to the mother board 40 via a USB (Universal Serial Bus). Furthermore, a power unit 45 is connected to the mother board 40. When the power is supplied to the mother board 40 from the power unit 45, as well as the main CPU 41 of the mother board 40 booting up, the power is supplied to the gaming board 50 via the PCI bus and the CPU 51 boots up.

An instrument or a device, which generates an input signal to be input into the main CPU 41, and an instrument or a device, an operation of which is controlled by a control signal transmitted from the main CPU 41, are connected to the main body PCB 60 and the door PCB 80. The main CPU 41, based on the input signal input into the main CPU 41, by executing the game program and game system program stored in the RAM 43, carries out a calculation process, stores a result thereof in the RAM 43, and carries out a process transmitting the control signal to each instrument or device as a control process with respect to each instrument or device.

A hopper 61, a coin detector 62, a graphic board 63, the speaker 31, the touch sensitive screen 15, the bill validator 23, the ticket printer 32, a KEY switch 33S, the data indicator 34 and the card reader 35 are connected to the main body PCB 60. The hopper 61, being installed in the cabinet 11, based on the control signal transmitted from the main CPU 41, pays a prescribed number of coins into the coin tray 26 through the coin payout opening 25. The coin detector 62, being provided inside the coin payout opening 25, when detecting that the prescribed number of coins has been paid out through the coin payout opening 25, transmits a detection signal relating the fact to the main CPU 41. The graphic board 63, based on the control signal transmitted from the main CPU 41, controls an image display on the upper image display panel 30 and the lower image display panel 14. The credit quantity stored in the RAM 43 is displayed in the credit quantity display area CR (refer to FIG. 2) of the lower image display panel 14. Also, the coin payout quantity, and the number of coins which the player has bet, are displayed respectively in the payout quantity display area PY and the BET quantity display area BT (refer to FIG. 2) of the lower image display panel 14. Also, the graphic board 63 includes a VDP (Video Display Processor), which generates image data based on the control signal transmitted from the main CPU 41, and a video RAM or the like, which temporarily stores the image data generated by the VDP.

The bill validator 23 reads an image on a bill, and accepts a legitimate bill into the cabinet 11. Also, the bill validator 23, when accepting the legitimate bill, transmits a detection signal to the main CPU 41 corresponding to a value of the bill. The main CPU 41 stores a credit quantity corresponding to the value of the bill transmitted via the detection signal in the RAM 43. The ticket printer 32, based on the control signal transmitted from the main CPU 41, prints the bar code into which are encoded the data on the identification number etc. of the slot machine 10, the current date and time, and the credit quantity stored in the RAM 43, on a ticket, and outputs the ticket as the bar-coded ticket 32a. The KEY switch 33S, being provided on the keypad 33, when the keypad 33 is operated by the player, transmits an on signal corresponding to the keypad operated to the main CPU 41. The data indicator 34, based on the control signal transmitted from the main CPU 41, displays the data read by the card reader 35 and the data input by the player via the keypad 33. The card reader 35 reads the data from the smart card and transmits them to the main CPU 41 and, based on the control signal from the main CPU 41, carries out the writing of the data onto the smart card.

The various kinds of switch provided on the control panel 16, a reverter 22S, a coin counter 22C and a cold cathode tube 81 are connected to the door PCB 80. As previously described, a CASH OUT switch 17S corresponding to the CASH OUT button 17, a CHANGE switch 18S corresponding to the CHANGE button 18, a 1-BET switch 19S corresponding to the 1-BET button 19, a SPIN switch 20S corresponding to the SPIN button 20, and a MAX-BET switch 21S corresponding to the MAX-BET button 21 are provided on the control panel 16. Each switch 17S to 21S, when the corresponding button 17 to 21 is operated by the player, transmits an on signal corresponding to the button operated to the main CPU 41.

The coin counter 22C, being provided inside the coin acceptor 22, distinguishes whether or not a coin inserted into the coin acceptor 22 by the player is legitimate. Coins other than legitimate coins are ejected from the coin payout opening 25. Also, the coin counter 22C, when detecting a legitimate coin, transmits a detection signal for the relevant coin to the main CPU 41. The reverter 22S, operating based on the control signal transmitted from the main CPU 41, sorts coins recognized as the legitimate coins by the coin counter 22C into a cash box (not shown) disposed in the slot machine 10, or into the hopper 61. That is, in the event that the hopper 61 is filled with coins, the reverter 22S sorts the legitimate coins into the cash box. Meanwhile, in the event that the hopper 61 is not filled with coins, the reverter 22S sorts the legitimate coins into the hopper 61. The cold cathode tube 81, functioning as a backlight disposed on a back of each of the lower image display panel 14 and the upper image display panel 30, comes on based on the control signal transmitted from the main CPU 41.

The slot machine 10 having the above configuration, firstly, when the power is turned on in the power unit 45 shown in FIG. 4, boots up the mother board 40 and gaming board 50. When the mother board 40 and gaming board 50 are booted up, processes distinct to each are carried out in parallel. That is, in the gaming board 50, the CPU 51 carries out a reading of the preliminary authentication program stored in the boot ROM 52 and, in accordance with the preliminary authentication program read, carries out the preliminary authentication confirming and certifying in advance that no alteration of the authentication program has been carried out, before it is downloaded onto the mother board 40.

Meanwhile, in the mother board 40, the main CPU 41 executes the BIOS stored in the ROM 42, and expands compressed data embedded in the BIOS to the RAM 43. Then, the main CPU 41 executes the BIOS expanded to the RAM 43, and carries out a diagnosis and initialization of each kind of peripheral device. Subsequently, the main CPU 41 carries out a reading of the authentication program stored in the ROM 55, via the PCI bus. Furthermore, the main CPU 41 carries out a process storing the authentication program read in the RAM 43. Next, the main CPU 41 accesses the memory card 54 attached to the card slot 54S via an IDE bus. Then, the main CPU 41 carries out a reading of the game program and the game system program stored in the memory card 54. Next, the main CPU 41, in accordance with the authentication program stored in the RAM 43, carries out an authentication confirming and certifying that no alteration of the game program and the game system program read has been carried out.

In the event that the authentication process finishes normally, the main CPU 41 stores the authenticated game program and game system program, including the first game program, in the RAM 43. Then, the main CPU 41 accesses the GAL 55 attached to the IC socket 55S via the PCI bus, reads the payout ratio setting data from the GAL 55, and stores them in the RAM 43. Also, the main CPU 41, as well as carrying out a reading of the country identification information stored in the ROM 55 of the gaming board 50, via the PCI bus, stores the country identification information read in the RAM 43. After carrying out these kinds of process, the main CPU 41, by sequentially reading and executing the basic game program (the first program) stored in the RAM 43, implements the basic game. By this means, the main CPU 41 functions as the processor.

Hereafter, a description will be given of details of an execution process of the basic game, referring to the flowchart shown in FIG. 7. Firstly, the main CPU 41 judges whether or not a coin has been bet (step S1). In this process, the main CPU 41 judges whether or not it has received an on signal transmitted from the 1-BET switch 19S when the 1-BET button 19 is pressed, or an on signal transmitted from the MAX-BET switch 21S when the MAX-BET button 21 is pressed. In step S1, if it judges that the coin has been bet, a step S1 judgment result being “Yes”, the main CPU 41 subtracts the number of coins which the player has bet from the credit quantity stored in the RAM 43, and updates a value of the credit quantity displayed in the credit quantity display area CR shown in FIG. 2 (step S2). Also, the main CPU 41, as well as storing the number of coins bet in the RAM 43, displays it in the BET quantity display area BT shown in FIG. 2.

Next, the main CPU 41, after the basic game execution process shown in FIG. 7 has been started, or after a basic game carried out immediately before has finished, judges whether or not it is a first bet (step S3). If it is the first bet, a step S3 judgment result being “Yes”, the main CPU 41, based on the random number, determines the disposition aspect of the display areas S1 to S9 with respect to the sections A to O provided on the lower image display panel 14 (step S4). For example, the main CPU 41 generates a random number which is an integer in a numeric range of “1” to “3”, and employs the disposition aspect 1 if a value of the random number generated is “1”, employs the disposition aspect 2 if the value is “2”, and employs the disposition aspect 3 if the value is “3”. Then, the main CPU 41, referring to the data stored in the RAM 43 shown in FIG. 5A, fixes the positions of the display areas S1 to S9 on the screen of the lower image display panel 14, among the sections A to O positioned on the lower image display panel 14, based on the correlation between each section in the disposition aspect employed in step S3, and the display areas S1 to S9. Then, the main CPU 41 displays a symbol on the graphic board 63 via the main body PCB 60, inside each display area in the fixed position (step S5). Then, the main CPU 41 judges whether or not the SPIN button 20 has been pressed by the player (step S6). In this process, the main CPU 41 judges based on whether or not it has received an on signal transmitted from the SPIN switch 20S when the SPIN button 20 has been pressed by the player. If it judges that the SPIN button 20 has not been pressed, a step S6 judgment result being “No”, the main CPU 41 returns to the process of step S1.

If, in step S1, the main CPU 41 judges that no coin has been bet, the step S1 judgment result being “No”, the main CPU 41 judges whether or not a coin has already been bet (step S7). If the coin has already been bet, a step S7 judgment result being “Yes”, the main CPU 41 shifts to step S6, and judges whether or not the SPIN button 20 has been pressed. Contrarily, if not even one coin has been bet, the step S7 judgment result being “Yes”, the main CPU 41 returns to the process of step S1.

If the player presses the SPIN button 20 in a condition in which the coin has been bet, the step S6 judgment result being “Yes”, the main CPU 41 determines the symbols to be redisplayed in the display areas S1 to S9 (step S8). In this process, the main CPU 41 determines the symbols to be redisplayed in the display areas S1 to S9 by executing the redisplayed symbol determination process program, which is read from the memory card 54 and stored in the RAM 43. Next, the main CPU 41 carries out a symbol display control process, using the lower image display panel 14 (step S9). By means of this process, first, a symbol is scroll displayed inside each display area S1 to S9, disposed in accordance with the disposition aspect determined in step S3, on the lower image display panel 14. Then, the main CPU 41 sequentially stops the scroll displays in the display areas S1 to S9, in accordance with the scroll stopping order stored in the RAM 43, shown in FIG. 5B.

When the scroll displays in all the display areas have stopped, the main CPU 41 judges whether or not a combination of symbols stop displayed along a payout line considered to be activated matches the winning combination which results in shifting to the second game (step S10). That is, the main CPU 41, first, referring to the number of coins bet stored in the RAM 43 and to the data shown in FIGS. 6A to 6C, judges the payout lines considered to be activated in the disposition aspect with which the relevant game has been carried out. Then, the main CPU 41 compares the combinations of symbols redisplayed in the display areas through which the payout lines considered to be activated pass with the winning combination which results in shifting to the second game, and judges whether or not there is a match. Then, if a matching combination of symbols has been redisplayed, a step S10 judgment result being “Yes”, the main CPU 41 executes a second game program stored in the RAM 43 (step S11). By this means, the player can play the second game a prescribed number of times. Then, when the second game has been played the prescribed number of times, one basic game finishes, and the main CPU 41 returns to step S1 and adopts a waiting condition, repeatedly carrying out the processes of step S1 and step S7 until the player bets the credit in order to start a next game.

Contrarily, in step S10, if it is judged that the combination of symbols stop displayed along the payout line considered to be activated does not match the winning combination which results in shifting to the second game, the step S10 judgment result being “No”, the main CPU 41 judges whether or not the combination of symbols stop displayed along the payout line considered to be activated matches another winning combination (step S12). If the combination of symbols stop displayed along the payout line considered to be activated matches any winning combination (except, however, the winning combination which results in the second game being started), a step S12 judgment result being “Yes”, the main CPU 41 carries out the payout of the coins, in accordance with the dividend of the relevant winning combination and the number of coins bet (step S13). That is, if the paid out coins are to be credited, the main CPU 41 adds a number of credits equivalent to a number of coins paid out to the credit quantity stored in the RAM 43. Also, if the coins are to be paid out, the main CPU 41 transmits a control signal to the hopper 61, and carries out a payout of a prescribed number of coins. At this time, the coin detector 62 counts a number of coins paid out from the hopper 61 and, when a count value reaches a specified number, transmits a payout completion signal to the main CPU 41. By this means, the main CPU 41 stops an operation of the hopper 61, and finishes the coin payout process. When the coin payout process has finished, one basic game finishes, and the main CPU 41 returns to the process of step S1.

In step S12, if there is no match with any winning combination (step S12, No), one basic game finishes directly, and the main CPU 41 returns to the process of step S1.

As heretofore described, according to the slot machine of the embodiment, the display aspect of the plurality of symbols, rather than being, as heretofore known, a standardized one disposed in, for example, a matrix form, changes into a variety of aspects when the coin is bet. For this reason, being rich in visual change, it is possible to prevent the player from becoming easily bored.

### Second Embodiment

Next, a description will be given of a second embodiment of the invention. As regards the hardware configuration and the disposition aspects of the display areas, the second embodiment is the same as the first embodiment, but a selection method of the disposition aspect is different from that of the first embodiment. That is, in the first embodiment, when the betting of the coin is first carried out, one of the disposition aspect 1, the disposition aspect 2 or the disposition aspect 3 is selected based on the random number, but in the second embodiment, the player him or herself can select the disposition aspect.

Hereafter, in describing the second embodiment, as the appearance of the slot machine, the details of the disposition aspects, and the configuration of the control circuit are the same as those in FIG. 1, FIGS. 3A to 3C (including FIGS. 5A, 5B and 6A to 6C) and FIG. 4 respectively, their descriptions will be omitted. Therefore, hereafter, a description will be given of a basic game execution process, which the main CPU 41 executes, referring to FIG. 8. Regarding steps in FIG. 8 which carry out the same processes as the basic game execution process shown in FIG. 7, the same reference numerals will be appended, and a detailed description will be omitted.

In the basic game execution process in the embodiment, if the main CPU 41 judges that the coin has been bet by the player (step S1, Yes), it subtracts the number of coins which the player has bet from the credit quantity stored in the RAM 43 (step S2). Then, if the betting of the coin is the first bet after the basic game execution process shown in FIG. 8 has been started, or after the basic game carried out immediately before has finished (step S3, Yes), the main CPU 41 starts the timing of the predetermined time (taken here to be 30 seconds), using its own built-in timing function (step S20). Next, as shown in FIG. 9, a selection button SEL, for allowing the player to select the disposition aspect, is displayed in a bottom right of the lower image display panel 14 screen (step S21). The selection button SEL is an image configured of numbers “1”, “2” and “3”, and a frame surrounding each number. Next, the main CPU 41 judges whether or not 30 seconds have elapsed since starting the timing in step S20 (step S22). If 30 seconds have elapsed, a step S22 judgment result being “Yes”, the main CPU 41 shifts to step S6, and judges whether or not the SPIN button 20 has been pressed. Herein, in step S3, if it is not the first bet after the basic game execution process shown in FIG. 8 has been started (step S3, No), the main CPU 41 shifts to the process of step S22, without carrying out the processes of the heretofore described steps S20 and S21.

As opposed to this, in step S22, if 30 seconds have not elapsed, the step S22 judgment result being “No”, the main CPU 41 judges whether or not the player has touched the selection button SEL displayed on the lower image display panel 14 (step S23). That is, it judges whether or not the player has touched an area, within the touch sensitive screen 15 disposed on the screen surface of the lower image display panel 14, in which the selection button SEL is displayed. If it judges that the player has not touched the area in which the selection button SEL is displayed, a step S23 judgment result being “No”, the main CPU 41 shifts to step S6, and judges whether or not the SPIN button 20 has been pressed. Contrarily, if it judges that the player has touched the area in which the selection button SEL is displayed, the step S23 judgment result being “Yes”, the main CPU 41 displays the nine symbols on the lower image display panel 14, in accordance with the disposition aspect which the player has selected (step S24). That is, the main CPU 41, firstly, judges inside which frame, among the frames surrounding each of the numbers “1”, “2” and “3” on the selection button SEL displayed on the lower display panel 14, is the area the player has touched. Then, the main CPU 41, referring to the data from the memory card 54 stored in the RAM 43, shown in FIG. 5A, displays the nine symbols on the lower image display panel 14, in accordance with a disposition aspect corresponding to a number displayed in the area inside the frame which the player has touched.

After displaying the nine symbols in step S24, the main CPU 41, in step S6, judges whether or not the SPIN button 20 has been pressed and, if it judges that it has not been pressed, the step S6 judgment result being “No”, returns to the process of step S1. If, in step S1, the main CPU 41 judges that no coin has been bet (step S, No), it judges, in step S7, whether or not the coin has already been bet. Then, if the coin has already been bet (step S7, Yes), the main CPU 41 shifts to step S6, and judges whether or not the SPIN button 20 has been pressed. Contrarily, if not even one coin has been bet (step S7, No), the main CPU 41 returns to the process of step S1.

The processes from step S6 onwards are the same as those of the previously described first embodiment. That is, if the main CPU 41 judges that the SPIN button 20 has been pressed by the player (step S6, Yes), the main CPU 41 determines the symbols to be redisplayed in the display areas S1 to S9 disposed on the screen of the lower image display panel 14, by means of the process of step S8. Then, the main CPU 41, in step S9, carries out the symbol display control process using the lower image display panel 14 and, after scroll displaying each symbol displayed inside the display areas S1 to S9, sequentially stops the scrolling, and redisplays the symbols. When the symbols have been redisplayed in all the display areas, the main CPU 41 judges, in step S10, whether or not a combination of symbols matching the winning combination which results in shifting to the second game has been displayed along a payout line considered to be activated. If the matching combination of symbols has been displayed (step S10, Yes), the main CPU 41 executes the second game in S11 and, when the second game finishes, returns to the process of step S1.

Also, in step S10, if the combination of symbols matching the winning combination which results in shifting to the second game has not been displayed along the payout line considered to be activated (step S10, No), the main CPU 41, shifting to step S12, judges whether or not the combination of symbols stop displayed along the payout line considered to be activated matches another winning combination. Then, if there is a match with any winning combination (step S12, Yes), the main CPU 41, after, in step S13, paying out the coins in accordance with the dividend of the relevant winning combination and the number of coins bet, returns to step S1. Also, in step S12, if there is no match with any winning combination (step S12, No), the main CPU 41 returns directly to the process of step S1.

In the slot machine of the heretofore described embodiment, in the event that the coin is bet first, the main CPU 41 starts the timing with the timer in step S20, and the player can select a desired disposition aspect until 30 seconds have elapsed, that is, until the step S22 judgment result becomes “No”.

### Third Embodiment

Next, a description will be given of a third embodiment of the invention. In this embodiment too, the hardware configuration and the disposition aspects of the display areas are the same as those of the first and second embodiments, but a selection method of the disposition aspect differs from those of these embodiments. That is, in the third embodiment, when the redisplay of the symbols is carried out, in the event that a specific combination of symbols is displayed along the payout line considered to be activated, one of the disposition aspect 1, the disposition aspect 2 or the disposition aspect 3 is selected based on the random number. Hereafter, in describing the third embodiment, as the appearance of the slot machine, the details of the disposition aspects, and the configuration etc. of the control circuit are all the same as those in FIG. 1 to FIGS. 6A to 6C, their descriptions will be omitted. Therefore, hereafter, a description will be given of a basic game execution process, which the main CPU 41 executes, referring to FIG. 10. However, regarding steps in FIG. 10 which carry out the same processes as the basic game execution process shown in FIG. 7, the same reference numerals will be appended, and a detailed description will be omitted.

In the basic game execution process in the embodiment, if the main CPU 41 judges that the coin has been bet by the player (step S1, Yes), it subtracts the number of coins which the player has bet from the credit quantity stored in the RAM 43 (step S2). Then, the main CPU 41 judges, in step S6, whether or not the SPIN button 20 has been pressed by the player. If the player has not pressed the SPIN button 20 (step S6, No), the main CPU 41 returns to the process of step S1. Also, in step S1, if the coin has not been bet (step S1, No), the main CPU 41 judges, in step S7, whether or not the coin has already been bet by the player and, if no coin has yet been bet (step S7, No), returns to the process of step S1. As opposed to this, if the coin has already been bet (step S7, Yes), the main CPU 41 judges, in step S6, whether or not the SPIN button 20 has been pressed.

In step S6, if the main CPU 41 judges that the SPIN button 20 has been pressed by the player (step S6, Yes), the main CPU 41 determines the symbols to be redisplayed in the display areas S1 to S9 disposed on the screen of the lower image display panel 14, by means of the process of step S8. Then, the main CPU 41, in step S9, carries out the symbol display control process using the lower image display panel 14 and, after scroll displaying each symbol displayed inside the display areas S1 to S9, sequentially stops the scrolling, and redisplays the symbols. When the symbols have been redisplayed in all the display areas, the main CPU 41 judges, in step S10, whether or not a combination of symbols matching the winning combination which results in shifting to the second game has been displayed along the payout line considered to be activated. If the matching combination of symbols has been displayed (step S10, Yes), the main CPU 41 executes the second game in S11.

When the second game finishes, the main CPU 41, based on the random number, determines the disposition aspect of the display areas S1 to S9 with respect to the sections A to O (refer to FIG. 2) provided on the lower image display panel 14 (step S30). For example, the main CPU 41 generates a random number which is an integer in the numeric range of “1” to “3”, and employs the disposition aspect 1 if the value of the random number generated is “1”, employs the disposition aspect 2 if the value is “2”, and employs the disposition aspect 3 if the value is “3”. Then, the main CPU 41, referring to the data stored in the RAM 43 shown in FIG. 5A, fixes the positions of the display areas S1 to S9 on the screen of the lower image display panel 14, among the sections A to O positioned on the lower image display panel 14, based on the correlation between each section in the disposition aspect employed in step S3, and the display areas S1 to S9. Then, the main CPU 41, by means of the graphic board 63 via the main body PCB 60, displays each symbol on the lower image display panel 14 inside each display area in the fixed position (step S31). Subsequently, the main CPU 41 returns to the process of step S1, and repeatedly carries out the processes of step S1 and step S7 until the player bets the coin in order to start the next basic game.

Also, in step S10, if the combination of symbols matching the winning combination which results in shifting to the second game has not been displayed along the payout line considered to be activated (step S10, No), the main CPU 41, shifting to step S12, judges whether or not the combination of symbols stop displayed along the payout line considered to be activated matches another winning combination. Then, if there is a match with any winning combination (step S12, Yes), the main CPU 41, after carrying out, in step S13, the payout of the coins in accordance with the dividend of the relevant winning combination and the number of coins bet, returns to step S1. Also, in step S12, if there is no match with any winning combination (step S12, No), the main CPU 41 returns directly to the process of step S1.

In the slot machine in the heretofore described embodiment, in the event that a combination of symbols, among the nine symbols redisplayed on the lower image display panel 14, redisplayed along the payout line considered to be activated matches the winning combination which results in the second game being started, that is, a predetermined combination of symbols, the disposition aspect of the symbols changes. For this reason, the winning combination which results in the second game being started does not only have a role as a winning combination which is a trigger for the second game, which carries out a paying out of a high dividend to the player, but also has a new role of determining whether or not the disposition aspect of the symbols changes. By this means, in comparison with heretofore known gaming machines, it is possible to cause the player to have a greater interest in the combinations of symbols redisplayed along the payout lines considered to be activated. Not only this, in the event that the combination of symbols matching the winning combination which results in the second game being started has been redisplayed along the payout line considered to be activated, as well as giving satisfaction to the player, it is possible, by varying the basic game carried out after the second game has finished, to make it unlikely for the player to become bored with the game in the slot machine.

In the embodiment, after the second game of step S11 has finished, the main CPU 41 carries out the processes of steps S30 and S31, and changes the disposition aspect of the display areas but, not being limited to this, it is also acceptable, before carrying out the process of step S11, to determine the disposition aspect by carrying out the process of step S30, and change the disposition aspect after the second game of step S11 has finished. Also, it is also acceptable, after carrying out the processes of steps S30 and S31, and changing the disposition aspect of the display areas, to carry out processes relating to the second game of step S11. Furthermore, in step S12, when judging whether or not the combination of symbols redisplayed matches another combination, it is also acceptable, when it is judged that there is a match with any specific winning combination among a plurality of winning combinations, to carry out the processes of steps S30 and S31. In this case, it is also acceptable that the dividend is not necessarily fixed for the heretofore described specific winning combination. That is, in the event that a combination of symbols redisplayed along the payout line considered to be activated matches the heretofore described specific winning combination, it is also acceptable that only the disposition aspect of the display areas changes, without the coins being paid out to the player.

### Fourth Embodiment

Next, a description will be given of a fourth embodiment of the invention. In this embodiment too, the hardware configuration and the disposition aspects of the display areas are the same as those of the thus far described first to third embodiments. In the embodiment, a feature is that every time the prescribed time elapses, the slot machine 10 reselects the disposition aspect of the display symbols. Hereafter, in describing the fourth embodiment, as the appearance of the slot machine, the details of the disposition aspects, and the configuration etc. of the control circuit are all the same as those in FIG. 1 to FIGS. 6A to 6C, their descriptions will be omitted. Hereafter, a description will be given of a basic game execution process, which the main CPU 41 executes, referring to FIG. 11. However, regarding steps in FIG. 11 which carry out the same processes as the basic game execution process shown in FIG. 7, the same reference numerals will be appended, and a detailed description will be omitted.

In the basic game execution process in the embodiment, if the main CPU 41 judges that the coin has been bet by the player (step S1, Yes), it subtracts the number of coins which the player has bet from the credit quantity stored in the RAM 43 (step S2). Then, the main CPU 41 judges whether or not a predetermined time (taken here to be 15 minutes) has elapsed since last reselecting the disposition aspect of the display symbols (step S40). Herein, a description will be given hereafter regarding at which point the main CPU 41 starts the timing using the timer. In step S40, if the main CPU 41 judges that the predetermined time has not elapsed, a judgment result being “No”, the main CPU 41 judges, in step S6, whether or not the SPIN button 20 has been pressed by the player. As opposed to this, if the main CPU 41 judges, in step S40, that the predetermined time has elapsed, the judgment result being “Yes”, the main CPU 41, based on the random number, determines the disposition aspect of the display areas S1 to S9 with respect to the sections A to O (refer to FIG. 2) provided on the lower image display panel 14 (step S41). For example, the main CPU 41 generates a random number which is an integer in the numeric range of “1” to “3”, and employs the disposition aspect 1 if the value of the random number generated is “1”, employs the disposition aspect 2 if the value is “2”, and employs the disposition aspect 3 if the value is “3”. Then, the main CPU 41, referring to the data stored in the RAM 43 shown in FIG. 5A, fixes the positions of the display areas S1 to S9 on the screen of the lower image display panel 14, among the sections A to O positioned on the lower image display panel 14, based on the correlation between each section in the disposition aspect employed in step S3, and the display areas S1 to S9. Then, the main CPU 41, by means of the graphic board 63 via the main body PCB 60, displays each symbol on the lower image display panel 14 inside each display area in the fixed position (step S42). Subsequently, the main CPU 41 starts anew the timing, by means of the timer, of the predetermined time (that is, 15 minutes) (step S43).

In this way, in the embodiment, the main CPU 41 starts the timing of the predetermined time every time it reselects the disposition aspect of the display areas to be displayed on the lower image display panel 14, by carrying out the processes of steps S41 and S42. Then, every time the coin is bet, the main CPU 41 judges whether or not the predetermined time has elapsed (step S40) and, if the predetermined time has elapsed (step S40, Yes), carries out the selection of the disposition aspect of the display areas.

When the main CPU 41 starts the timing with the timer in step S43, it judges, in step S6, whether or not the SPIN button 20 has been pressed by the player. The main CPU 41 judging, in step S6, whether or not the SPIN button 20 has been pressed, if it judges that it has not been pressed, the step S6 judgment result being “No”, the main CPU 41 returns to the process of step S. If the main CPU 41 judges, in step S1, that the coin has not been bet (step S1, No), it judges, in step S7, whether or not the coin has already been bet. Then, if the coin has already been bet (step S7, Yes), the main CPU 41 shifts to step S6, and judges whether or not the SPIN button 20 has been pressed. Meanwhile, if not even one coin has been bet (step S7, No), the main CPU 41 returns to the process of step S1.

Also, if the main CPU 41 judges that the SPIN button 20 has been pressed by the player (step S6, Yes), the main CPU 41, by means of the process of step S8, determines the symbols to be redisplayed in the display areas S1 to S9 disposed on the screen of the lower image display panel 14. Then, the main CPU 41 carries out the symbol display control process using the lower image display panel 14 and, after scroll displaying each symbol displayed inside the display areas S1 to S9, sequentially stops the scrolling, and redisplays the symbols. When the symbols have been redisplayed in all the display areas, the main CPU 41 judges, in step S10, whether or not a combination of symbols matching the winning combination which results in shifting to the second game has been displayed along the payout line considered to be activated. If the matching combination of symbols has been displayed (step S10, Yes), the main CPU 41 executes the second game in step S1 and, when the second game finishes, returns to the process of step S1.

Also, in step S10, if the combination of symbols matching the winning combination which results in shifting to the second game has not been displayed along the payout line considered to be activated (step S10, No), the main CPU 41, shifting to step S12, judges whether or not the combination of symbols stop displayed along the payout line considered to be activated matches another winning combination. Then, if there is a match with any winning combination (step S12, Yes), the main CPU 41, after, in step S13, paying out the coins in accordance with the dividend of the relevant winning combination and the number of coins bet, returns to step S1. Also, in step S12, if there is no match with any winning combination (step S12, No), the main CPU 41 returns directly to the process of step S1.

In the slot machine of the heretofore described embodiment, the main CPU 41, when reselecting the disposition aspect of the display areas in the lower image display panel 14, starts anew the timing of the predetermined time (herein, 15 minutes). Then, when the coin has been bet by the player, in the event that 15 minutes have not elapsed since last reselecting the disposition aspect of the display symbols, the main CPU 41 carries out the display of the symbols in accordance with the disposition aspect in its current form, while in the event that 15 minutes have elapsed, the main CPU 41 selects anew the disposition aspect of the display areas. For this reason, for example, even when the paying out of the high dividend in the gaming machine does not occur for a long time, and the player is playing the game aimlessly, as it is possible to add to the game an extra feature of changing the disposition aspect of the symbols, it is possible to prevent the player from becoming easily bored.

Although, in the embodiment, the disposition of the display areas is reselected on the condition that the coin has been bet by the player (that is, step S1, Yes), it is also acceptable to arrange in such a way that the disposition of the display areas is reselected every time a prescribed time elapses, regardless of the betting of the coin. In order to realize this, for example, rather than simply carrying out the processes of steps S40 to S43 after step S2 of FIG. 11, it should be arranged in such a way that the same processes as in steps S40 to S43 (hereafter, these processes will be referred to as steps S40′, S41′, S42′ and S43′) are also carried out after the step S7 judgment result has become “No”. In this case, it is arranged that, in the event that the step S7 judgment result is “No”, the main CPU 41 carries out the process of step S40′ and, in the event that the step S40′ judgment result is “No”, the main CPU 41 returns to step S1. Also, it is arranged that when the step S40′ judgment result is “Yes”, and the processes of steps S41′ to S43′ have been finished, the main CPU 41 returns to step S1.

Also, in the heretofore described first to fourth embodiments, any one of the disposition aspects, from among the disposition aspect 1, the disposition aspect 2 and the disposition aspect 3, is selected based on the random number but, apart from this, it is also acceptable to fix in advance an order of the disposition aspects to be selected (for example, the disposition aspect 1→the disposition aspect 2→the disposition aspect 3→the disposition aspect 1→ . . . ), and change the disposition aspect in accordance with the relevant order.

Furthermore, in the heretofore described first to fourth embodiments, the liquid crystal display device is used as the display, but it is also acceptable, in place of this, to use mechanical reels and a liquid crystal display device disposed on a front of the relevant reels. In this case, for example, five reels, on a peripheral surface of each of which a plurality of symbols is depicted, are correlated one each to a column of the sections L, M and N, a column of the sections J, A, D, G and K, a column of the sections B, E and H, a column of the sections C, F and I, and a column of the section O, shown in FIG. 2, and positioned aligned side by side on the same horizontal axis. Also, in the liquid crystal display device disposed on a front side (a player side) of the reels, no reflector plate or the like being provided in at least an area of the sections A to O shown in FIG. 2, a configuration is such that when a liquid crystal layer of the relevant liquid crystal display device attains a transmissive condition, the symbols of the reels positioned at a rear can be visually perceived by the player. Then, in accordance with the disposition aspect selected by means of the generated random number or a player instruction, an area which takes on a transmissive condition, and an area which takes on a light intercepting condition, are formed appropriately on a screen of the liquid crystal display device, in such a way that it becomes one of the disposition aspects shown in FIGS. 3A to 3C.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A gaming machine, in which an execution of a game is possible on a condition of a game start operation by a player being accepted, comprising:
a display having a plurality of display areas for displaying symbols;
a memory which, as well as storing a plurality of kinds of disposition aspect of the display areas on a screen of the display, stores predetermined payout lines corresponding to each disposition aspect; and
a processor which, as well as controlling the display, controls an implementation of a game, wherein
the processor fixes a position of each display area on the screen of the display in accordance with any one disposition aspect among the disposition aspects of the display areas stored in the memory, displays a symbol in each display area, redisplays the symbol displayed in each display area in accordance with an instruction from the player and, in the event that a combination of symbols, among the redisplayed symbols, for which an award should be provided is displayed, provides the award to the player.

2. The gaming machine according to claim 1, wherein
the processor, when the game start operation has been carried out by the player, selects anyone among the disposition aspects of the display areas stored in the memory, fixes the position of each display area on the screen of the display in accordance with the selected disposition aspect, and displays a symbol in each display area.

3. The gaming machine according to claim 1, further comprising:
a selection switch for selecting the plurality of disposition aspects stored in the memory, wherein
the processor fixes the position of each display area on the screen of the display in accordance with the disposition aspect, among the disposition aspects of the display areas stored in the memory, which the player has selected via the selection switch, and displays a symbol in each display area.

4. The gaming machine according to claim 1, wherein
the processor, in the event that a predetermined combination of symbols, among the redisplayed symbols, is displayed along the payout line, selects any one among the disposition aspects of the display areas stored in the memory, fixes the position of each display area on the screen of the display in accordance with the selected disposition aspect, and displays a symbol in each display area.

5. The gaming machine according to claim 1, further comprising:
a timer which measures a time, wherein
the processor, every time the timer measures a predetermined time, selects any one among the disposition aspects of the display areas stored in the memory, fixes the position of each display area on the screen of the display in accordance with the selected disposition aspect, and displays a symbol in each display area.
